(19) United States
(12) Patent Application Publication
(10) Pub. No.: US 2011/0254821 A1
(43) Pub. Date: Oct. 20, 2011

(54) IMAGE DISPLAY APPARATUS

(75) Inventor: Tomoya Onishi, Ayase-shi (JP)

(73) Assignee: CANON KABUSHIKI KAISHA, Tokyo (JP)

(21) Appl. No.: 13/085,221

(22) Filed: Apr. 12, 2011

(30) Foreign Application Priority Data
Apr. 14, 2010 (JP) 2010-093025

(51) Int. Cl. G06F 3/038

(52) U.S. Cl. 345/211

(57) ABSTRACT

An image display apparatus includes a rear plate that includes electron emitting sources, and a scanning line, and a face plate that includes a light emitting member, a rectangular anode electrode, and a power supply terminal configured to supply the potential to the anode electrode. The face plate includes first and second potential defining members and a resistance member configured to interconnect the first potential defining member and the second potential defining member. A relationship of R1<R2<R3 is satisfied, where R1 is a larger one of average resistance values of the first and second potential defining members per reference length, R2 is an average resistance value of the resistance member per reference length, and R3 is an average resistance value of the anode electrode per reference length in a direction parallel to a longitudinal direction of the resistance member.

### BACKGROUND OF THE INVENTION

1. Field of the Invention

The present invention relates to an image display apparatus, and more particularly to a structure of applying a potential to an anode electrode.

2. Description of the Related Art

Japanese Patent Application Laid-Open No. 2008-159449 discusses an image display apparatus that includes an electrode (common electrode) disposed around an anode electrode to apply a potential to the anode electrode. The anode electrode is formed by a plurality of metal backs that cover a plurality of phosphor layers. The metal backs are connected to each other by a resistance material, and high electric resistance of the resistance material suppresses a discharge current during discharging. The common electrode includes a plurality of electrode films arranged at intervals, and an annular resistance film for connecting the plurality of electrode films. Thus, when discharging occurs in any portion of the common electrode, a discharge current can be suppressed.

The common electrode described in Japanese Patent Application Laid-Open No. 2008-159449 has a structure almost similar in all portions, and resistance values are nearly equal and relatively high among all the portions of the common electrode. In such a common electrode, a voltage drop in the common electrode is large, and a potential applied to the anode electrode greatly varies from one portion to another of the anode electrode. This phenomenon leads to variance of luminance (luminance unevenness) among portions of the image display apparatus. To prevent discharging, the common electrode can have a resistance value of a certain level. This imposes a limit on reduction of the resistance value of the common electrode. When discharging occurs, a level of influence on the image display apparatus depends on which component of the apparatus is affected by the discharging. Especially when a functionally important component such as an electron emitting source or its driving circuit is affected by the discharging, the influence on the image display apparatus is large.

### SUMMARY OF THE INVENTION

The present invention is directed to an image display apparatus that can suppress variance of luminance among each portion of the image display apparatus while reducing influence of discharging on an electron emitting source or its driving circuit.

According to an exemplary embodiment of the present invention, first and second potential defining members relatively low in resistance (resistance value R1) are connected to an anode electrode. Voltage drops at the first and second potential defining members are small, and hence variance of potential among portions of the anode electrode is suppressed. A resistance value R2 of a resistance member for connecting the first potential defining member and the second potential defining member is set lower than an average resistance value R3 of the anode electrode, and hence a voltage drop at one of the potential defining members not connected to a power supply terminal is suppressed. Thus, variance of luminance among each portion of the image display apparatus is suppressed. The first and second potential defining members are disposed in parallel with a scanning line driven when electron emitting sources are sequentially driven. The scanning line can receive a large current to drive many electron emitting sources simultaneously. Therefore, even when discharging occurs between the first and second potential defining members and the scanning line, influence of the discharging to the electron emitting source and the driving circuit can be limited to a minimum.

According to an aspect of the present invention, an image display apparatus includes a rear plate that includes electron emitting sources, and a scanning line, and a faceplate that includes a light emitting member, a rectangular anode electrode, and a power supply terminal configured to supply the potential to the anode electrode. The faceplate includes first and second potential defining members and a resistance member configured to interconnect the first potential defining member and the second potential defining member. A relationship of R1<R2<R3 is satisfied: R1 being larger one of average resistance values of the first and second potential defining members per reference length, R2 being an average resistance value of the resistance member per reference length, and R3 being an average resistance value of the anode electrode per reference length in a direction parallel to a longitudinal direction of the resistance member.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic plan view illustrating a face plate according to the present invention.

FIG. 2 is a schematic sectional view illustrating an image display apparatus according to the present invention.

FIG. 3 is a schematic plan view illustrating a pixel portion of a rear plate according to the present invention.

FIG. 4 is a schematic sectional view illustrating a spacer of the image display apparatus according to the present invention.

FIGS. 5A to 5C are schematic views illustrating effects of luminance unevenness reduction according to the present invention.

FIG. 6 is a schematic plan view illustrating a resistance measuring method of the face plate according to the present invention.

FIG. 7 is a schematic plan view illustrating a configuration of a resistance member according to the present invention.

FIG. 8 is a schematic plan view illustrating a current path of the face plate according to the present invention.

FIG. 9 is a graph illustrating a level of luminance unevenness reduction according to the present invention.

FIGS. 10A and 10B are schematic plan views illustrating comparative examples according to the present invention.

### DESCRIPTION OF THE EMBODIMENTS

Various exemplary embodiments, features, and aspects of the invention will be described in detail below with reference to the drawings.

An image display apparatus according to the present invention can be applied to a field-electron emitting display (FED) that forms an image by irradiation of an electron beam from an electron emitting source. The image display apparatus is particularly suitable to a flat panel type FED that includes a face plate and a rear plate arranged close to each other and receives a high electric field, because discharging easily occurs and a discharge current easily increases.

An exemplary embodiment of the present invention is specifically described by taking an example of, among FEDs, an image display apparatus (SED) that uses a surface-conduction electron emitting device with reference to the drawings.

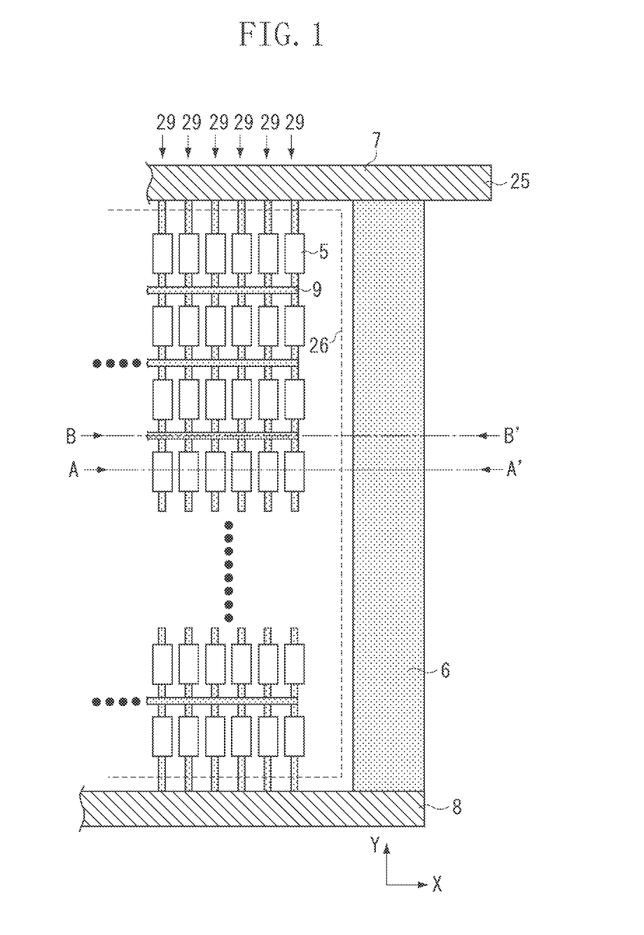

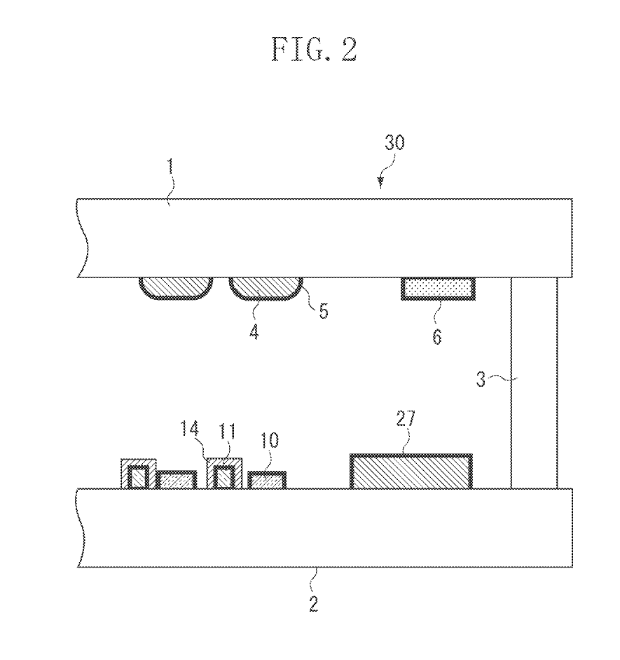

FIG. 1 is a schematic plan view illustrating a face plate of the image display apparatus according to the exemplary embodiment of the present invention. FIG. 2 is a schematic sectional view illustrating a section of the image display apparatus cut along a line A-A′ illustrated in FIG. 1.

As illustrated in FIG. 2, a vacuum-tight container 30 includes a face plate 1, a rear plate 2, and a side wall 3. Pressure is reduced in the vacuum-tight container 30 to maintain a vacuum condition. A glass substrate such as soda lime glass, alkaline free glass, or a high strain-point glass in which an alkaline component is adjusted is used for the face plate 1 to transmit light emitted from a phosphor described below. A glass substrate similar to that for the face plate 1 is suitably used for the rear plate 2 to match its linear expansion coefficient with that of the face plate 1. The side wall 3 is made of a glass member similar to that of the face plate 1 or the rear plate 2, or a metal member showing similar linear expansion coefficient. The side wall 3 is fixed to the face plate 1 and the rear plate 2 by flit glass or a low melting-point metal.

The face plate 1 includes a light emitting member formed to emit light when hit by electrons. The light emitting member is, for example, a phosphor layer 4 coated with a phosphor material. For the phosphor layer 4, a phosphor material that emits light when irradiated with an electron beam can be used. To acquire a color display, a P22 phosphor used in a cathode-ray tube (CRT) field is suitably used in terms of color reproduction and luminance.

The face plate 1 includes a rectangular anode electrode 26 configured to cover the light emitting member and defined to a potential higher than that of an electron emitting source 10. The anode electrode 26 is an area in which the phosphor layer 4, a metal back 5, and an anode resistance member 9 are arranged. The phosphor layer 4 includes a plurality of metal backs 5 well-known in the CRT and arranged in a matrix to cover the light emitting member. The metal back 5 is disposed to apply a desired acceleration voltage to the phosphor layer 4 and increase light extraction efficiency by reflecting light generated at the phosphor layer 4. The metal back 5 can be made of any material as long as it enables reflection of light and transmission of electron beams. A thin aluminum film can be suitably used since it provides high electron transmittance and reflectance.

The anode resistance member 9 is disposed as a wiring for supplying a desired potential to the metal back 5. The anode resistance member 9 needs a resistance value of a certain level or less to permit flowing of a current of an electron beam entered to the metal back 5. In contrast, it is desirable that the anode resistance member 9 have a resistance value of a certain level or more to suppress a discharge current between the rear plate 2 and the face plate 1. Accordingly, there is a desirable range for the resistance value of the anode resistance member 9. Any material that provides a desirable resistance value can be used for the anode resistance member 9. However, a material such as a ruthenium oxide, ITO, or ATO can be suitably used because control of the resistance value is easy.

Members for supplying power from a high-voltage power source to the anode resistance material 9 are provided on an outer circumferential side of the anode electrode 26. As illustrated in FIG. 1, these members are a resistance member 6, a first potential defining member 7, and a second potential defining member 8, which are characteristic elements of the present invention.

The first and second potential defining members 7 and 8 are disposed, outside the anode electrode 26, along two opposing sides of the anode electrode 26 in parallel with a scanning line 12, and respectively connected to the anode electrode 26. One of the potential defining members 7 and 8 is connected to a power supply terminal 25. According to the present exemplary embodiment, the first potential defining member 7 includes the power supply terminal 25 that supplies a potential from a high-voltage power source (not illustrated) to the anode electrode 26 via a high voltage terminal (not illustrated). The second potential defining member 8 is roughly parallel to the first potential defining member 7, and located on an outer circumference opposing the anode electrode 26. The first potential defining member 7 and the second potential defining member 8 are typically located along the sides of the anode electrode 26, and can be arranged with lengths roughly equal to the sides of the anode electrode 26.

The potential defining members 7 and 8 are made of low resistance materials so that there can be practically no voltage drop caused by currents of electron beams. As materials for the potential defining members 7 and 8, metal thin films or sintered materials of pastes in which metal powders are mixed can be used. Considering an easy preparation method, materials sintering pastes to which silver powders, glass flits, and vehicles are added can be suitably used.

The resistance member 6 electrically connects the first potential defining member 7 and the second potential defining member 8 to each other. The resistance member 6 is located, outside the anode electrode 26, along at least one of the other two sides of the anode electrode 26, in other words, sides in which neither of a first potential defining member 7 and a second potential defining member 8 is disposed. According to the present exemplary embodiment, resistance members 6 are located on both sides sandwiching the anode electrode 26. However, only one resistance member 6 can be disposed. A resistance value of the resistance member 6 is set higher than those of the first potential defining member 7 and the second potential defining member 8. Setting the resistance value of the resistance member 6 higher than those of the first potential defining member 7 and the second potential defining member 8 enables suppression of a discharge current when discharging occurs near the resistance member 6 while electrically interconnecting the first and second potential defining members 7 and 8. As in the case of the anode resistance member 9, any material can be used for the resistance member 6 as long as it enables acquisition of a desired resistance value. A material such as a ruthenium oxide, ITO, or ATO can be suitably used because it facilitates control of the resistance value. To adjust the resistance value, effective resistance can be reduced by arranging a low resistance electrode in the resistance member 6.

In each column 29 of the metal back 5 extending in a direction parallel to a longitudinal direction of the resistance member, the first potential defining member 7, the plurality of metal backs 5, and the second potential defining member 8 are sequentially connected in series by the plurality of metal back resistance members 9. The second potential defining member 8 is connected to the first potential defining member 7, which includes the power supply terminal 25, via the resistance member 6. Thus, a potential is applied to the metal backs of each column 29 from the first potential defining member 7 and from the second potential defining member 8 via the resistance member 6. Electrons emitted from the electron emitting source 10 are accelerated by the anode electrode 26 to collide with the light emitting member (phosphor layer 4).

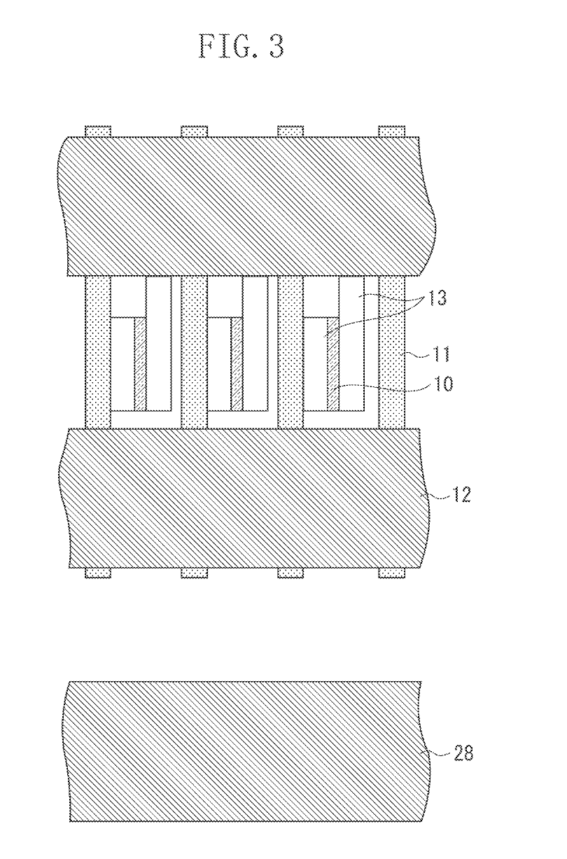

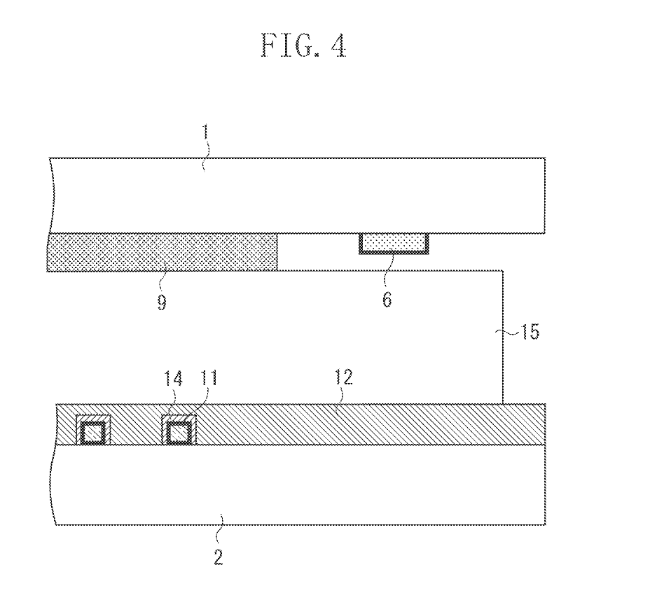

FIG. 3 is a schematic plan view illustrating a vicinity of the electron emitting source of the rear plate 2. FIG. 4 is a schematic sectional view cut along a line B-B′ of the image display apparatus illustrated in FIG. 1. Referring to FIGS. 3 and 4, the rear plate 2 includes electron emitting sources 10 formed in a matrix, information wirings 11, scanning lines 12, electrodes 13 for supplying power to the electron emitting sources 10 from the information wirings 11 and the scanning lines 12, and inter wiring insulating layers 14. Referring to FIG. 2, the rear plate 2 includes a driving circuit 27 for the electron emitting sources. In a portion opposing the first and second potential defining members 7 and 8, a discharge wiring 28 connected to none of the electron emitting sources and the driving circuit is disposed. The electron emitting source 10 is subjected to simple matrix driving to emit an electron beam to the face plate 1.

In the sectional portion illustrated in FIG. 4, a spacer 15 for supporting atmospheric pressure applied on the face plate 1 and the rear plate 2 may be disposed. The spacer 15 is in contact with the anode resistance member 9 and the scanning line 12. Both ends of the spacer 15 are fixed by a fixing method (adhesive or fixing member not illustrated). In this configuration, the spacer 15 is located over an image area formed by the anode electrode 26 and the resistance member 6.

Next, the potential defining members 7 and 8, the resistance member 6, and the anode resistance member 9 that are features of the present invention are described in more detail.

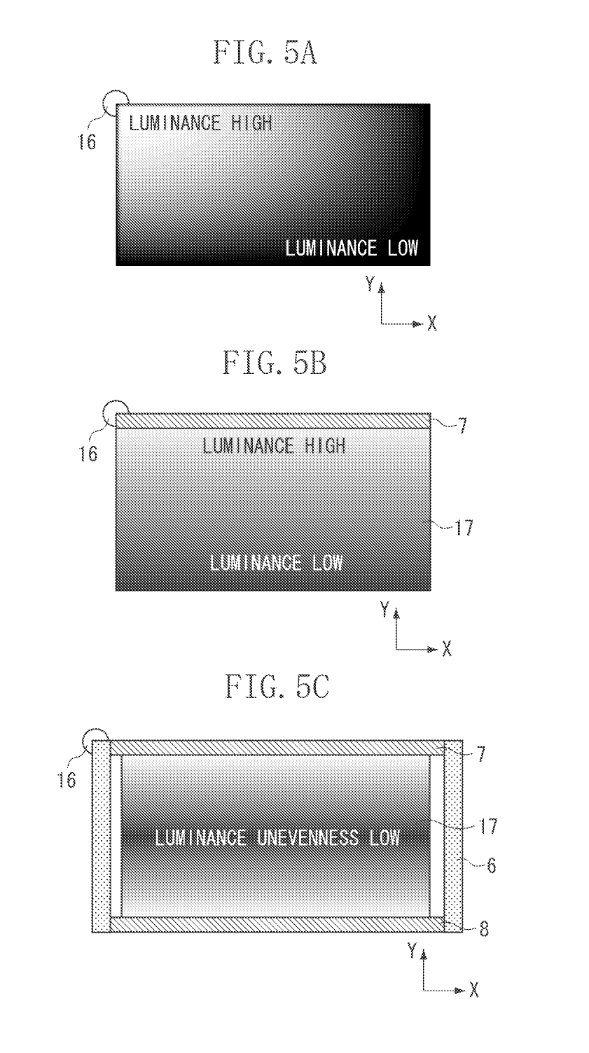

Referring to FIGS. 5A to 5C, the arrangement of the first potential defining member 7 and the second potential defining member 8 is described. A current generated by irradiation of an electron beam flows from the high-voltage power source (not illustrated) into the electron emitting source 10 of the rear plate 2 via the anode electrode 26. In this case, when neither of the first potential defining member 7 and the second potential defining member 8 is present as a common electrode, a voltage drop greatly varies, which causes luminance unevenness of an image. FIGS. 5A to 5C are schematic views illustrating luminance distributions generated by voltage drops. FIG. 5A illustrates a luminance distribution of an image display area 17 (i.e., luminance distribution of the anode electrode 26) when neither of the first and second potential defining members 7 and 8 is present. A potential is applied to the metal backs 5 via only the anode resistance material 9 for interconnecting these metal backs. Thus, on the high voltage terminal 16 side, a voltage drop at the anode resistance material 9 is small and luminance is high. However, at a corner opposing the high voltage terminal 16, a voltage drop at the anode resistance material 9 is large and luminance is low.

FIG. 5B illustrates a luminance distribution when only the potential defining member 7 is disposed. Resistance R1 of the first potential defining member 7 is low, and hence a voltage drop in a horizontal direction is small, and variance of luminance distribution in the horizontal direction is also small. However, in a position opposing the first potential defining member 7 and across the anode electrode 26, a voltage drop is large and luminance is low. Thus, there is still large luminance unevenness in a perpendicular direction.

FIG. 5C illustrates a luminance distribution when the second potential defining member 8 is disposed in a position opposing the first potential defining member 7 and, across the anode electrode 26 and the first and second potential defining members 7 and 8 are interconnected by the resistance member 6. In this case, the resistance value R1 indicates larger one of resistance values of the first potential defining member 7 and the second potential defining member 8. When a resistance value R2 of the resistance member 6 is larger than a resistance value R3 of the anode resistance member 9, a voltage drop of the second potential defining member 8 is small, and luminance drop near the first and second potential defining members 7 and 8 is small as illustrated in FIG. 5C. In the center of the image area, a luminance drop is largest. However, its drop amount is small, and luminance unevenness is suppressed in the image display area. Thus, a voltage drop is lowered by satisfying a relationship of R1<R2<R3 so that the luminance unevenness in image area can be reduced. Definitions of R1, R2, and R3 and a range of resistance value are described in detail below.

An arranging direction of the first potential defining member 7 and the second potential defining member 8 is described. When the electron emitting sources 10 are subjected to simple matrix driving in line-sequential system, in a direction along the scanning line 12, electrons from the plurality of electron emitting sources 10 are simultaneously injected to the metal back 5. Thus, when the first and second potential defining members 7 and 8 are arranged in a direction orthogonal to the scanning line 12, simultaneously flowing currents overlap each other, causing a voltage drop increase. Advisably, therefore, the first potential defining member 7 and the second potential defining member 8 should extend in a direction parallel to the scanning line 12 driven simultaneously when the electron emitting sources 10 are driven line-sequential.

Referring to FIGS. 1 and 4, the arrangement of the anode electrode 26 is described. In the case of the flat panel type FED, a high voltage (high electric field) is applied between the face plate 1 and the rear plate 2, and hence discharging may occur. The face plate 1 and the rear plate 2 generate capacitance, and hence a current equivalent to a charge amount stored in the capacitance flows during discharging, which may cause a serious defect in the image display apparatus. Thus, in the anode electrode 26 forming the image area, the metal backs 5 of low resistance are interconnected by the anode resistance member 9. A resistance value of the anode resistance member 9 per reference length in the longitudinal direction of the resistance member 6 is larger than that of the metal back 5 per reference length in the longitudinal direction of the resistance member 6. The anode resistance member 9 can have a resistance value of a level that can limit a discharge current. By increasing a resistance value of the face plate 1 in an in-plane direction, a current effectively flowing into the capacitance during discharging can be reduced, thereby suppressing a discharge current.

In contrast, resistance of the first potential defining member 7 and the second potential defining member 8 must be reduced for a functional need. Thus, when discharging occurs in the first potential defining member 7 and the second potential defining member 8, a discharge current flowing into a portion of the rear plate 2 opposed to each of the first and second potential defining members 7 and 8 may increase.

It is in the electron emitting source 10 or its driving circuit (drive IC) 27 that a defect occurs due to flowing-in of a discharge current. Especially, discharging to the scanning line 12 extending in parallel with the first potential defining member 7 and the second potential defining member 8 is a problem. However, as illustrated in FIG. 3, when the scanning line 12 and the information wiring 11 are compared with each other, the scanning line 12 is thicker and lower in resistance. This is for a reason that the electron emitting sources 10 are subjected to simple matrix driving in line-sequential system, and the electron emitting sources 10 on the scanning line 12 are simultaneously driven, and thus more currents flow through the scanning line 12. Thus, even when discharging occurs on the scanning line 12, since the scanning line 12 easily absorbs a great current, influence on the electron emitting source 10 or its driving circuit 27 is limited.

As illustrated in FIG. 3, in a portion of the rear plate 2 opposed to the first potential defining member 7 or the second potential defining member 8, a discharge wiring (wiring for discharge bypassing) 28, which is low in resistance and not connected to the electron emitting source 10 or the driving circuit 27, can be disposed. This facilitates prevention of a serious defect in the image display apparatus. As described above, the first potential defining member 7 and the second potential defining member 8 are advisably formed in parallel with the scanning line 12. The wiring 28 for discharge bypassing can therefore be formed as in the case of the scanning line 12, and its formation is easy.

As illustrated in FIG. 4, the spacer 15 maybe located in a place where the resistance member 6 is disposed. It is because advisably a place to locate the spacer 15 is on the scanning line 12 and a place to fix the spacer 15 is outside the image area. As is known, at an end of the spacer 15, no electric field distribution is formed in a parallel planar shape different from the case in the image area, and a potential distribution is distorted. In such a place, discharging is highly likely to occur. A peripheral edge of the anode electrode 26 orthogonal to the scanning line 12 is accordingly an area which is near the scanning line 12 connected to the electron emitting source 10 and in which discharging easily occurs. Thus, by setting the resistance value R2 of the resistance member 6 located in this portion larger than the resistance value R1 of the first and second potential defining members 7 and 8 (R1<R2), a discharge current can be suppressed, and influence of discharging on the electron emitting source 10 or the driving circuit 27 can be reduced. The resistance value R1 is a larger one of the resistance values of the first and second potential defining members 7 and 8.

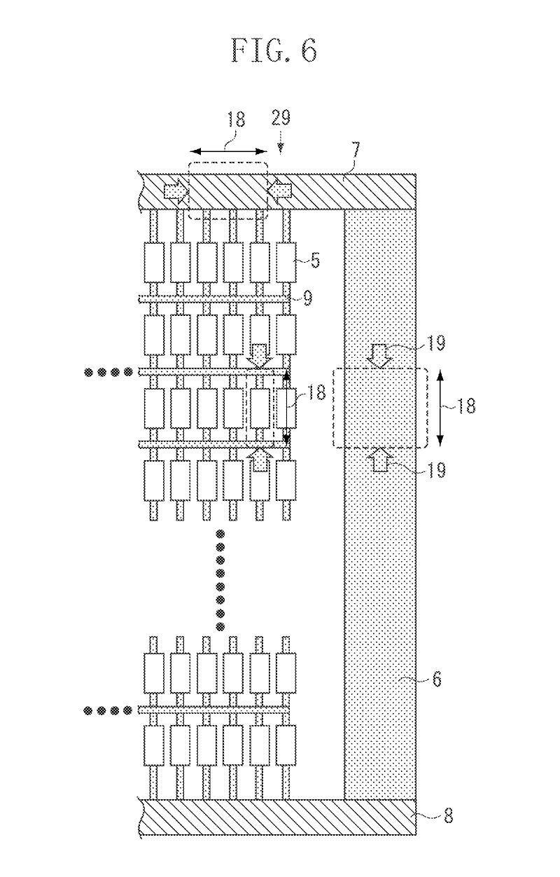

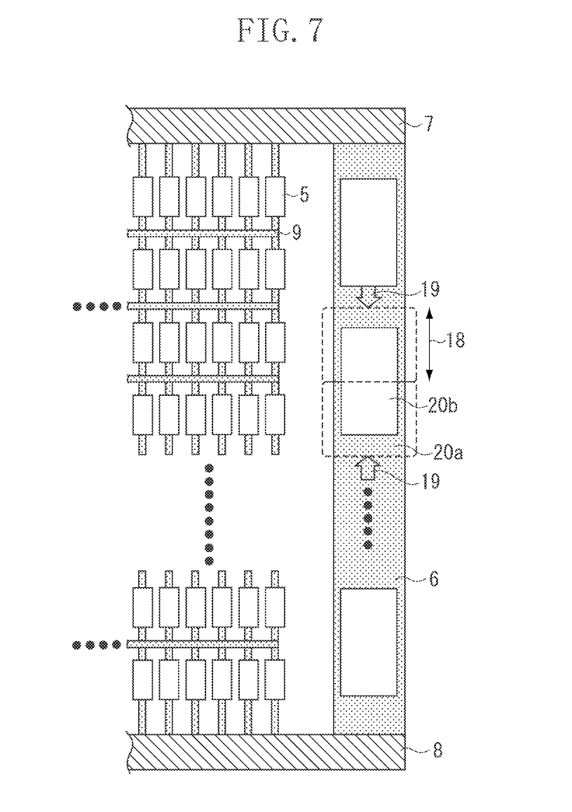

Next, referring to FIGS. 6 and 7, definitions and a measuring method of the resistance values (R, R2, and R3) of the first and second potential defining members 7 and 8, the resistance member 6, and the anode electrode 26 are described. These resistance values are defined by average resistance values of each member per reference length. Specifically, one metal back 5 and a set of adjacent metal back resistance members 9 sandwiching this metal back 5 from both sides at each column 29 of the metal back are considered. Further, a section (area surrounded by a broken line illustrated in FIG. 6) defined by centers of the adjacent metal back resistance members 9 from both sides in the longitudinal direction of the resistance member 6, the centers being set as both ends, is considered. In one example, a length of this section is a reference length 18. When one pixel in the anode electrode 26 corresponds to one metal back 5, a length of a pixel measured in a direction parallel to a direction in which the resistance member 6 extends is a reference length 18. Average resistance values of the first and second potential defining members 7 and 8, the resistance member 6, and the anode electrode 26 are defined as resistance values per reference length 18.

As a measuring method, to prevent a change in resistance value caused by a sneak path, measurement is performed by cutting out a relevant place or cutting a resistance portion. Resistance is measured by a tester at a measuring position 19 during resistance measurement so that a resistance value per reference length of each member is calculated. As illustrated in FIG. 7, to adjust resistance, the first and second potential defining members 7 and 8 and the resistance member 6 may be formed in a composite configuration with a resistance material 20a and an electrode 20b. In such a case, when the reference length 18 during resistance measurement is set, resistance of the electrode 20b may be measured. In such a case, a measuring place is determined by taking a repeating pitch of the resistance material 20a and the electrode 20b into consideration, and average resistance of the first and second potential defining members 7 and 8 and the resistance member 6 per reference length 18 is measured. For example, a resistance value becomes R/L×reference length, where L is a repeating pitch of the resistance material 20a and the electrode 20b and R is resistance per pitch L. To acquire resistance values per reference length of the metal back 5 and the metal back resistance member 9, a section where only the metal back 5 is present or a section where the metal back resistance member 9 is present is taken into consideration, and a resistance value of this section can be converted to a resistance value per reference length.

To sum up, there is a relationship of R1<R2<R3 in resistance among the first and second potential defining members 7 and 8, the resistance member 6, and the anode electrode 26. The resistance value R1 is larger one of average resistance values of the first and second potential defining members 7 and 8 per reference length 18. The resistance value R2 is a resistance value of the average resistance member 6 per reference length 18. The resistance value R3 is an average resistance value of the anode electrode 26 per reference length 18 in the direction parallel to the longitudinal direction of the resistance member.

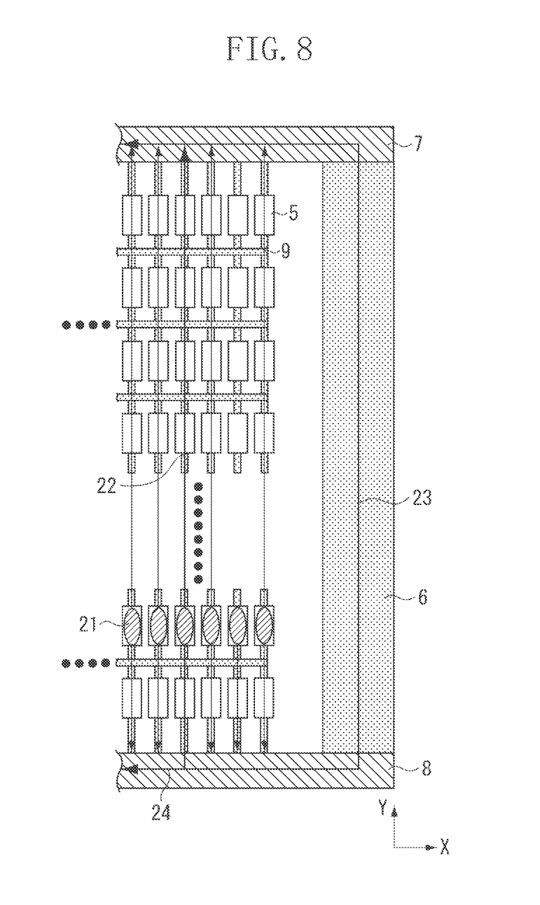

Referring to FIG. 8, the relationship of R1<R2R<R3 is described in more detail. Effects of the present invention can be acquired as long as the resistance values R1, R2, and R3 satisfy the relationship of R1<R2<R3. However, to enhance the effects of the present invention, the resistance values R1 and R2 can be set appreciably smaller than the resistance value R3. FIG. 8 illustrates a current path when the electron emitting sources 10 of the image display apparatus are driven line-sequential to emit light. In FIG. 8, an arrow direction indicates a flowing direction of electrons. The electrons flow from an electron beam irradiation unit 21 through a plurality of paths. The electrons flow into the high-voltage power source via the high voltage terminal (not illustrated). As a first path, there is a path 22 through which a current flows from the electron beam irradiation unit 21 to the potential defining member 7. As second paths, there are paths 23 and 24 through which a current flows to the second potential defining member 8, and then passes through the resistance member 6 to flow into the first potential defining member 7. The path 24 is present when the resistance members 6 are located on both sides sandwiching the anode electrode 26. Thus, the currents from the electron beam irradiation unit 21 simultaneously flow to the potential defining members 7 and 8 and the resistance member 6, and hence a larger current flows through the paths 23 and 24 as compared with the path 22. When the entire area is lit, a current equivalent to the number of pixels N of an X direction flows. As illustrated in FIGS. 5A to 5C, to eliminate almost all voltage drops in a horizontal direction, a voltage drop can be reduced by double digits or more for the resistance value R1 with respect to the resistance value R3, and a resistance ratio of about R1<R3/(100×N) can be set with respect to the number of pixels N of the X direction. For the paths 23 and 24, from the standpoint of suppressing voltage drops, low resistance can similarly be set. Specifically, a voltage drop at the resistance member 6 can be set equal to or less than that at the anode electrode resistance member 9. Thus, a resistance ratio between the resistance values R2 and R3 can be approximately equal to a ratio of amounts of simultaneously flowing currents. When the resistance members 6 are located on both sides, a current amount flowing through the resistance members 6 is a half of the number of simultaneously driven elements (i.e., N/2). A resistance ratio of about R2<R3/(N/2) can accordingly be set. However, a required resistance ratio changes depending on required luminance unevenness or driving conditions, and hence the above mentioned conditions are in no way limiting.

As described above, according to the present exemplary embodiment, the first potential defining member 7 and the second potential defining member 8 (a larger resistance value is R1) are located in parallel with each other, and interconnected by the resistance material 6 (resistance R2), and there is a relationship of R1<R2<R3 with the resistance value (R3) of the anode electrode 26. As a result, luminance unevenness caused by a voltage drop in the image area can be reduced while a risk during discharging is suppressed.

Hereinafter, the present invention is described in more detail by taking specific examples.

Exemplary example 1 is the image display apparatus illustrated in FIG. 1. An overall configuration of a rear plate, a spacer, and the image display apparatus is as described in the exemplary embodiment. Among components of a face plate 1 that is a feature of the exemplary example 1, only a metal back 5, a resistance member 6, a first potential defining member 7, a second potential defining member 8, and an anode resistance member 9 are described.

The face plate 1 used in the exemplary example 1 was manufactured as follows.

(Step 1: formation of black matrix)

A black paste (containing black pigment and glass flit) was screen-printed in a matrix on a surface of a washed glass substrate (PD200 manufactured by ASAHI GLASS CO., LTD.), dried at 120° C., and then baked at 550° C. to form a black matrix (not illustrated) with a thickness of 5 micrometers. The screen printing was performed on conditions of an X-direction pitch of 200 micrometers, a Y-direction pitch of 600 micrometers, 300 pixels in an X direction, 100 pixels in a Y direction, and an aperture size X×Y of 150 μm×300 μm.

(Step 2: formation of anode resistance member 9)

A highly resistance paste mixed with a ruthenium oxide was applied on the black matrix by screen printing to form a pattern of the anode resistance member 9 illustrated in FIG. 1. The pattern after baking had a line width of 100 micrometers and a film thickness of 5 micrometers. This pattern was dried at 120° C. for 10 minutes to form a portion that became the anode resistance member 9. In this case, baking was performed at 500° C. without manufacturing any metal back 5 described below, and a resistance value of one pixel was measured to be 1MΩ.

(Step 3: formation of potential defining member)

A low-resistance paste containing silver powders and flit glass was applied by screen printing to form patterns of a first potential defining member 7 and a second potential defining member 8 with widths of 300 micrometers. These patterns were dried at 120° C. for 10 minutes to form portions that became the first and second potential defining members 7 and 8. In this case, baking was performed at 500° C. without executing a step described below, and a resistance value of a length 600 micrometers was measured to be 30 mΩ.

(Step 4: formation of resistance member 6)

A high resistance paste mixed with a ruthenium oxide, having resistance adjusted lower than in the step 2, was applied by screen printing to forma pattern of a resistance member 6 with a width of 600 micrometers. This pattern was dried at 120° C. for 10 minutes, and baked at 550° C. to form the resistance member 6. A resistance value was measured by partially cutting out the resistance member 6 to be 10 kΩ.

(Step 5: formation of phosphor layer 4)

In an opening portion of the black matrix, a phosphor layer 4 was formed between the anode resistance members 9 by a phosphor paste. For the phosphor, a P22 phosphor (red: Y₂O₂S:Eu, blue ZnS:Ag, Al, green ZnS:Cu, Al) was used. The phosphor layer 4 was formed in a desired place by screen printing, and dried at 120° C.

(Step 6: formation of metal back 5)

An intermediate film was formed by a filming that used acrylic emersion well-known in the CRT. Then, using a metal mask, an aluminum film that became a metal back was formed with a thickness of 0.1 micrometer by vacuum deposition. The intermediate film was baked at 450° C. to be pyrolyzed, thereby forming a metal back 5. The metal back 5 was connected to the anode resistance member 9.

An image display apparatus was manufactured by the face plate thus prepared. When an acceleration voltage of 10 kV was applied to perform image displaying, a good image having small luminance unevenness was acquired.

To forcibly generate discharging, the acceleration voltage was gradually increased. At 15 kV, discharging occurred in the resistance member 6. However, no image defect was generated.

Exemplary example 2 is described. A difference from the exemplary example 1 is a configuration of the resistance member 6. In the exemplary example 2, a resistance material 20a was formed with a width of 600 micrometers together with an anode resistance member 9. An electrode 20b was formed with a width of 500 micrometers, a length of 1 millimeter, and an interval of 200 micrometers together with a metal back 5. When resistance of the formed resistance member 6 was measured, a resistance value per reference length illustrated in FIG. 7 was 10 kΩ. Employing this manufacturing procedure enabled reduction of one step.

An image display panel was formed by the face plate thus manufactured. When a displayed image was observed, as in the case of the exemplary example 1, a good image was acquired, and no image defect occurred even when discharging was forcibly generated.

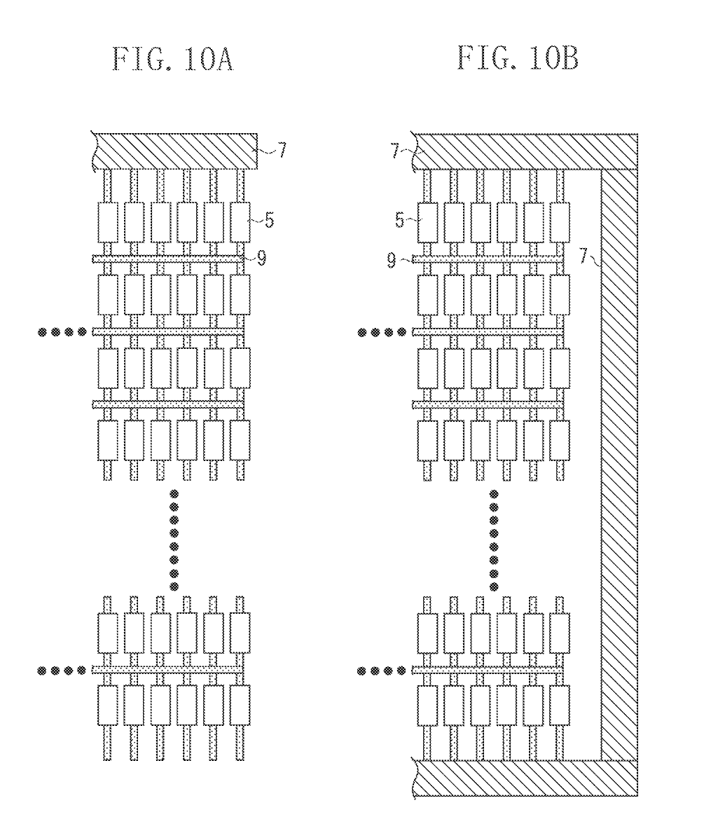

Comparative Example 1 is described. A basic configuration of the Comparative Example 1 is similar to that of the exemplary example 1 except for no inclusion of a second potential defining member 8 and a resistance member 6. As illustrated in FIG. 10A, a face plate was manufactured, and an image display apparatus was assembled to observe a displayed image.

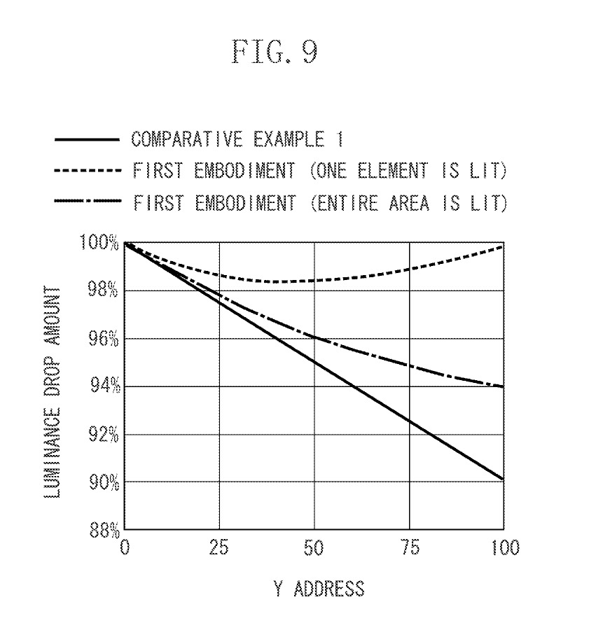

FIG. 9 illustrates a difference between the exemplary example 1 and the comparative example 1.FIG. 9 illustrates luminance unevenness of a lit image: a horizontal axis indicating addresses in a Y direction, and a vertical axis indicating in-plane luminance unevenness (100% at the brightest place). In the comparative example 1, in-plane luminance dropped about 10%. However, in the exemplary example 1, a luminance drop was about 6%. In the exemplary example 1, in the case of vertical one-line lighting, a luminance drop was about 1.5% even at the darkest portion.

Next, comparative example 2 is described. In the comparative example 2, as illustrated in FIG. 10B, a potential defining member 7 was formed to surround an anode electrode 26. When an image display apparatus was manufactured using a face plate thus prepared to observe a displayed image, luminance unevenness was 2% or less. However, to forcibly generate discharging, an acceleration voltage was gradually increased. Discharging occurred in a vertical-direction portion of the potential defining member at 15 kV, generating a serious pixel defect.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-093025 filed Apr. 14, 2010, which is hereby incorporated by reference herein in its entirety.

What is claimed is:

1. An image display apparatus comprising:
a rear plate that includes electron emitting sources formed in a matrix and driven line-sequential, and a scanning line driven when the electron emitting sources are driven line-sequential; and
a face plate that includes a light emitting member configured to emit light when hit by electrons, a rectangular anode electrode configured to cover the light emitting member and defined at a potential higher than that of the electron emitting sources, and a power supply terminal configured to supply the potential to the anode electrode, electrons emitted from the electron emitting sources being accelerated by the anode electrode to collide with the light emitting member,
wherein the face plate includes:
first and second potential defining members located outside the anode electrode in parallel with the scanning line along two opposing sides of the anode electrode, and each connected to the anode electrode, one of the potential defining members being connected to the power supply terminal; and
a resistance member located outside the anode electrode along at least one of other two sides of the anode electrode and configured to interconnect the first potential defining member and the second potential defining member, and
wherein a relationship of R1<R2<R3 is satisfied where R1 is a larger one of average resistance values per reference length of the first and second potential defining members, R2 is an average resistance value of the resistance member per reference length, and R3 is an average resistance value of the anode electrode per reference length in a direction parallel to a longitudinal direction of the resistance member.

2. The image display apparatus according to claim 1, wherein the anode electrode includes:
a plurality of metal backs arranged in a matrix and configured to cover the light emitting member; and
a plurality of metal back resistance members configured to sequentially connect, at each column of the metal back parallel to the longitudinal direction of the resistance member, the first potential defining member, the plurality of metal backs, and the second potential defining member in series, and
wherein the reference length is equal to a length of a section defined, at each column of the metal back, where centers of a set of adjacent metal back resistance members sandwiching one metal back from both sides in the longitudinal direction of the resistance member, are set as both ends.

3. The image display apparatus according to claim 1, wherein a resistance value of the anode resistance member per reference length in the longitudinal direction of the resistance member is larger than that of the metal back per reference length in the longitudinal direction of the resistance member.

4. The image display apparatus according to claim 1, wherein the rear plate further includes a discharge wiring not connected to the electron emitting source and a driving circuit of the electron emitting source in a portion opposed to the first and second potential defining members.
